(19) United States
(12) Patent Application Publication
(10) Pub. No.: US 2026/0163226 A1
(43) Pub. Date: Jun. 11, 2026

(54) MAGNETIC MOUNTING MECHANISM

(71) Applicant: MOTOROLA SOLUTIONS, INC., Chicago, IL (US)

(72) Inventors: Wey Chien Heng, Air Itam (MY); Chee Kit Chan, Bayan Lepas (MY); Chee Hean Loke, Georgetown (MY); Chin Wun Ng, Bayan Lepas (MY); Chor Cheow Ng, Butterworth (MY)

(21) Appl. No.: 18/975,726

(22) Filed: Dec. 10, 2024

(51) Int. Cl. H01Q 1/12; F16M 13/02

(52) U.S. Cl. CPC H01Q 1/125; F16M 13/022; F16M 2200/08

(57) ABSTRACT

A magnetic mounting mechanism includes a base with a chamber formed therein, a chassis positioned adjacent the base, a magnet extending into the chamber, and an articulator formed of an elastomeric material and positioned within the chamber between the chassis and the magnet. The articulator provides rotational and translational movement of the magnet relative to the base. A fastener couples the magnet to the chassis. The mechanism may include a metal washer configured to provide electrical grounding contact between the magnet and the chassis irrespective of the rotational and translational movement of the magnet relative to the base. The articulator may seal an aperture in the chamber irrespective of the magnet movement. Multiple magnets and articulators may be included to conform to curved surfaces.

### FIELD OF INVENTION

The present disclosure relates to magnetic mounting mechanisms, and more particularly to a flexible magnetic mounting mechanism for attaching devices to curved surfaces.

### BACKGROUND

Magnetic mounting mechanisms are used for attaching devices to various surfaces, particularly in automotive applications, such as the roof, hood, or trunk of a vehicle. While magnetic mounts work well on flat surfaces, they often struggle to maintain a secure hold on curved or irregular surfaces.

### BRIEF DESCRIPTION OF FIGURES

Non-limiting and non-exhaustive examples are described with reference to the following figures.

FIG. 1 illustrates an isometric view of an antenna assembly, according to aspects of the present disclosure.

FIG. 2 illustrates an exploded view of the antenna assembly of FIG. 1.

FIG. 3 illustrates an orthogonal view of the underside of the antenna assembly of FIG. 1.

FIG. 4 illustrates an exploded view of components of a magnetic mounting mechanism of the antenna assembly of FIG. 1.

FIG. 5 illustrates a section view of a magnetic mounting mechanism within the antenna assembly of FIG. 1.

FIG. 6 illustrates another section view of a magnetic mounting mechanism.

FIG. 7 illustrates a still further section view of a magnetic mounting mechanism, axially compressed relative to FIG. 6.

FIG. 8 illustrates a section view of multiple magnetic mounting mechanisms of an antenna assembly relative to a curved mounting surface.

FIG. 9 illustrates a section view of a flexible articulator in a compressed position, relative to a neutral position.

FIG. 10 illustrates a section view of the flexible articulator of FIG. 9 in a flexed position.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Magnetic mounting mechanisms are used for attaching devices to various surfaces, particularly in automotive applications, such as the roof, hood, or trunk of a vehicle. These mechanisms typically employ permanent magnets to create a strong but removable attachment between a device and a mounting surface. While magnetic mounts work well on flat surfaces, they often struggle to maintain a secure hold on curved or irregular surfaces. This is because traditional magnetic mounts have rigid structures that cannot conform to surface contours, resulting in reduced contact area and weakened magnetic attraction.

Additionally, many existing magnetic mounts lack adequate protection against environmental factors such as water and dust intrusion. This can lead to degradation of the mounting mechanism over time, especially in outdoor or harsh environments.

Furthermore, electrical grounding is often a critical requirement for mounted devices, particularly for antennas and other communication equipment. However, maintaining consistent ground contact can be challenging when the magnetic mount needs to accommodate movement or adjustment to attach to a curved surface.

There is a general need in the art for magnetic mounting mechanisms that can adapt to curved surfaces while maintaining a strong hold, provide environmental protection, and ensure reliable electrical grounding. Improvements in these areas could enhance the versatility and reliability of magnetically mounted devices across a wide range of applications.

According to an aspect of the present disclosure, a magnetic mounting mechanism is provided. The magnetic mounting mechanism includes a base including a chamber formed therein, a chassis positioned adjacent the base, a magnet extending into the chamber, and an articulator formed of an elastomeric material and positioned within the chamber between the chassis and the magnet. The articulator provides rotational and translational movement of the magnet relative to the base.

According to other aspects of the present disclosure, the magnetic mounting mechanism may include one or more of the following features. The magnetic mounting mechanism may further include a fastener coupling the magnet to the chassis. The fastener may be a threaded fastener threaded into engagement with the chassis. The base may be a base of a housing having a cover coupled to the base, and the chassis may be separable and removable from the housing. The chamber may be a first chamber, the magnet may be a first magnet, and the articulator may be a first articulator, and the magnetic mounting mechanism may further include a second chamber formed within the base and spaced apart from the first chamber, a second magnet positioned at least partially within the second chamber, and a second articulator formed of an elastomeric material and positioned within the second chamber between the chassis and the magnet. The second articulator may provide rotational and translational movement of the second magnet relative to the base independent of rotational and translational movement of the first magnet such that the first magnet and the second magnet are configured to simultaneously conform to a curved surface. The magnetic mounting mechanism may further include a metal washer configured to provide electrical grounding contact between the magnet and the chassis irrespective of the rotational and translational movement of the magnet relative to the base. The metal washer may be encapsulated between the magnet and the articulator and may indirectly provide electrical grounding contact between the magnet and the chassis via a threaded fastener. The chamber may include an open end through which the magnet is positioned within the chamber, and an upper surface opposite the open end, wherein the upper surface includes an aperture extending from the chamber to the chassis, and wherein the articulator simultaneously engages an interior wall of the aperture, the upper surface of the chamber, and the magnet. The articulator may seal the aperture irrespective of the rotational and translational movement of the magnet relative to the base.

According to another aspect of the present disclosure, a magnetic mounting mechanism is provided. The magnetic mounting mechanism includes a base including a chamber formed therein, a chassis positioned adjacent the base, a magnet extending into the chamber, an articulator positioned within the chamber between the chassis and the magnet, wherein the articulator provides rotational and translational movement of the magnet relative to the base, and a metal washer configured to provide electrical grounding contact between the magnet and the chassis irrespective of the rotational and translational movement of the magnet relative to the base.

According to other aspects of the present disclosure, the magnetic mounting mechanism may include one or more of the following features. The magnetic mounting mechanism may further include a threaded fastener threaded into engagement with the chassis and coupling the magnet to the chassis. The metal washer may be encapsulated between the magnet and the articulator. The threaded fastener may extend through an aperture of the base between the chassis and the magnet, and the articulator may seal the aperture irrespective of the rotational and translational movement of the magnet relative to the base. The chamber may be a first chamber, the magnet may be a first magnet, and the metal washer may be a first metal washer, and the magnetic mounting mechanism may further include a second chamber formed within the base and spaced apart from the first chamber, a second magnet positioned at least partially within the second chamber, and a second metal washer configured to provide electrical ground contact between the second magnet and the chassis irrespective of the rotational and translational movement of the second magnet relative to the base.

According to another aspect of the present disclosure, a magnetic mounting mechanism for an antenna assembly is provided. The magnetic mounting mechanism includes a chassis configured to support said antenna assembly, a threaded fastener coupled to the chassis, the threaded fastener extending through, in order: a magnet, a metal washer, an elastomeric articulator, and the chassis, wherein the elastomeric articulator provides rotational and translational movement of the magnet relative to the chassis.

According to other aspects of the present disclosure, the magnetic mounting mechanism may include one or more of the following features. The chassis may be coupled to a base of a housing, and the threaded fastener may extend through an aperture of the base. The base may define a chamber, and at least a portion of the magnet, the metal washer, and the elastomeric articulator may be positioned within the chamber. The elastomeric articulator may directly seal against the threaded fastener and directly seal against the aperture to prevent water and dust intrusion. The elastomeric articulator may directly seal against the magnet to encapsulate the metal washer between the elastomeric articulator and the magnet. Ground contact between the chassis and the magnet may be maintained via the metal washer and the threaded fastener irrespective of rotational and translational movement of the magnet relative to the chassis.

The foregoing general description of the illustrative embodiments and the following detailed description thereof are merely exemplary aspects of the teachings of this disclosure and are not restrictive.

The present disclosure relates to magnetic mounting mechanisms for attaching devices to curved surfaces. In some aspects, a magnetic mounting mechanism may include a base with a chamber, a chassis positioned adjacent to the base, a magnet extending into the chamber, and an articulator formed of an elastomeric material positioned within the chamber between the chassis and the magnet. The articulator may provide rotational and translational movement of the magnet relative to the base, allowing the magnetic mounting mechanism to conform to curved or irregular surfaces.

In some cases, the magnetic mounting mechanism may include multiple magnets and articulators to further enhance adaptability to various surface contours. The articulator may simultaneously engage an interior wall of an aperture in the base, an upper surface of the chamber, and the magnet, potentially providing a seal against the intrusion of environmental factors such as water and dust.

A metal washer may be incorporated in some configurations to provide electrical grounding contact between the magnet and the chassis. This grounding contact may be maintained irrespective of the rotational and translational movement of the magnet relative to the base. In certain aspects, the metal washer may be encapsulated between the magnet and the articulator.

The magnetic mounting mechanism may be particularly suitable for antenna assemblies or other devices requiring secure attachment to curved surfaces while maintaining electrical grounding. In some cases, a threaded fastener may couple the magnet to the chassis, extending through the magnet, metal washer, elastomeric articulator, and chassis in order.

These configurations may allow for a magnetic mounting mechanism that adapts to curved surfaces while maintaining a strong hold, provides environmental protection, and ensures reliable electrical grounding. The mechanism may be applicable in various fields including automotive, mobile communications, and other areas where secure, adaptable mounting on diverse surfaces may be beneficial.

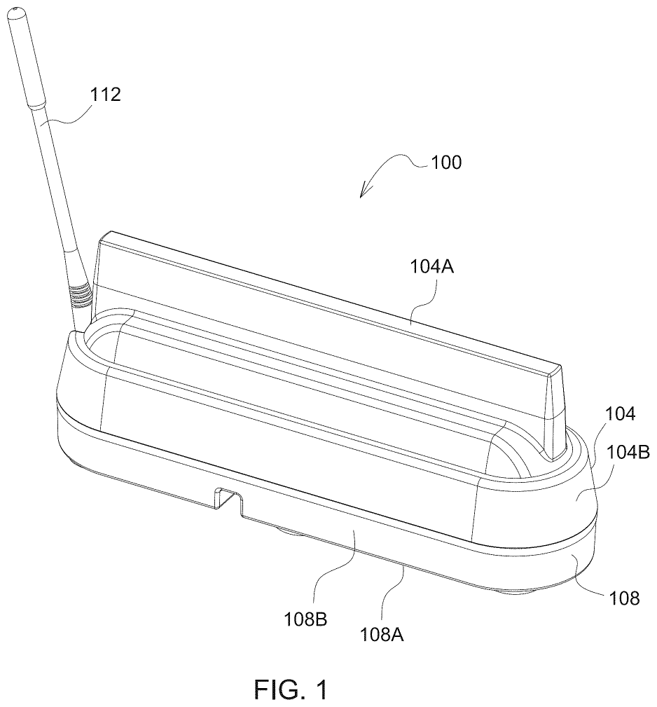

Referring to FIG. 1, an antenna assembly 100 includes a cover 104, a base 108, and an antenna 112. The cover 104 includes an upper side 104A and sidewalls 104B. The base 108 includes a lower side 108A and sidewalls 108B that meet the sidewalls 104B of the cover 104. The antenna 112 extends substantially vertically from the cover 104 to a height above the upper side 104A of the cover 104.

The cover 104 and base 108 form a housing for the antenna assembly 100, with the cover 104 positioned on top of the base 108. The sidewalls 104B of the cover 104 and the sidewalls 108B of the base 108 create a smooth, continuous exterior surface for the antenna assembly 100. In some embodiments, the base 108 has an oval or elongated and racetrack-shaped profile and is wider than much of the cover 104, providing stability.

The cover 104 and base 108 are separable from one another to provide access to internal components of the antenna assembly 100. In some implementations, the cover 104 may be shaped to accommodate various antenna elements within its interior. The antenna 112 may be configured to transmit and receive signals for communication purposes.

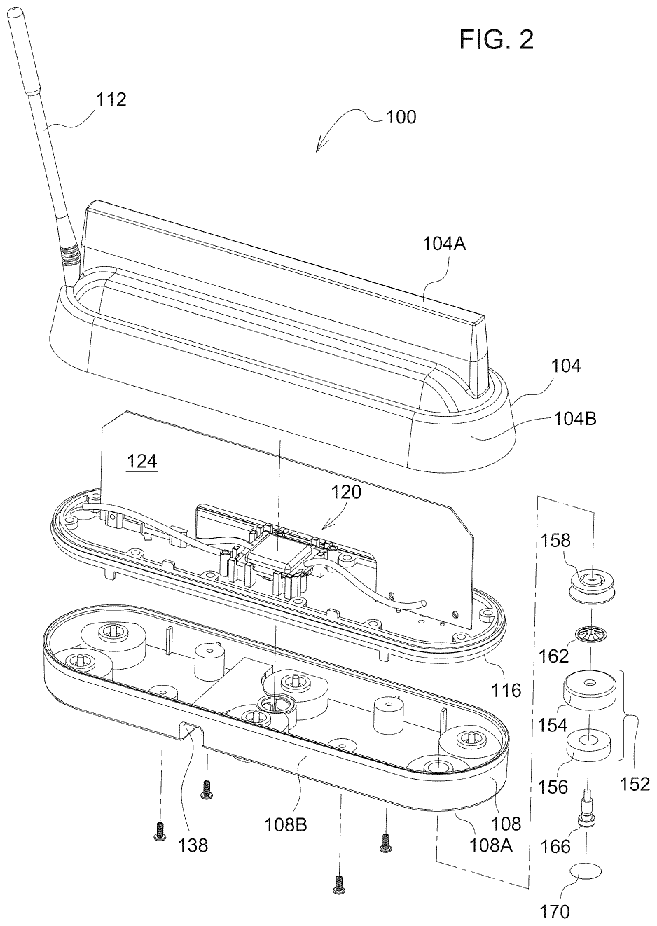

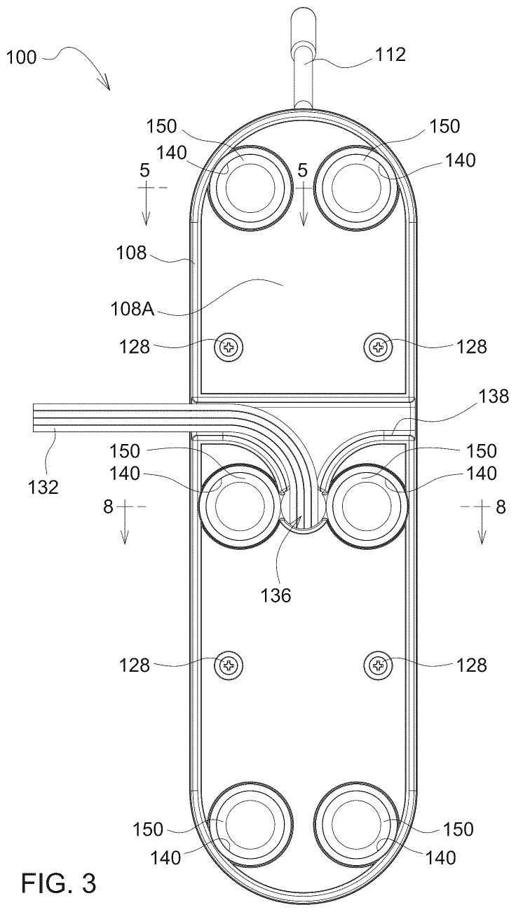

FIG. 2 illustrates an exploded view of the antenna assembly 100. The antenna assembly 100 includes the cover 104 and the base 108 that together form a housing. The antenna assembly 100 also includes a chassis 116 that is positioned within the housing (i.e., between the cover 104 and the base 108). In certain implementations, the chassis 116 may be separable and removable from the housing formed by the cover 104 and base 108. Antenna elements 124 and electronic components 120 are housed within the cover 104 and base 108 and fixed to the chassis 116. The chassis 116 supports the components positioned within the housing defined by the cover 104 and base 108. As described in greater detail below with respect to FIG. 3, the base 108 includes a cable channel 138 for routing cables 132 or other connections.

The antenna assembly 100 incorporates one or more (as shown, six) magnetic mounting mechanisms 150. Each magnetic mounting mechanism 150 includes an articulator 158, a metal washer 162, a magnet 152 formed of a magnetic element 156 housed within a magnet housing 154, and a fastener 166. In some embodiments, the magnetic mounting mechanisms 150 also include a cover 170 located at the bottom of the assembly and covering the fastener 166. The magnetic mounting mechanisms 150 allow for flexible attachment of the antenna assembly 100 to various surfaces. The articulators 158 permit rotational and translational movement of the magnets 152 relative to the base 108, enabling the antenna assembly 100 to adapt to different mounting surfaces.

The metal washers 162 are positioned between the articulators 158 and the magnet housings 154. The metal washers 162 maintain electrical grounding contact between the magnet 152, the fastener 166, and the chassis 116, even when the magnetic mounting mechanism is translated and rotated.

The threaded fasteners 166 secure the magnetic mounting mechanisms 150 to the chassis 116. The fasteners 166 are removable and therefore allow for adjustment and maintenance of the magnetic mounting mechanism 150. The covers 170 at the bottom of each magnetic mounting mechanism 150 may provide protection and a finished appearance to the underside of the antenna assembly 100.

FIG. 3 illustrates the lower side 108A of the base 108 of the antenna assembly 100. The lower side 108A of the base 108 houses multiple (as shown, six) magnetic mounting mechanisms 150. The magnetic mounting mechanisms 150 may be arranged in pairs along the length of the base 108. Each magnetic mounting mechanism 150 is positioned within a chamber 140 formed in the base 108. The chambers 140 may have a circular shape when viewed from below. Each chamber 140 includes an open end at the lower side 108A of the base 108 into which the magnetic mounting mechanism 150 is positioned.

The base 108 includes threaded fasteners 128. These threaded fasteners 128 may be positioned symmetrically near the corners of the base 108. The threaded fasteners 128 may serve to secure the base 108 to other components of the antenna assembly 100, such as the cover 104 and/or the chassis 116.

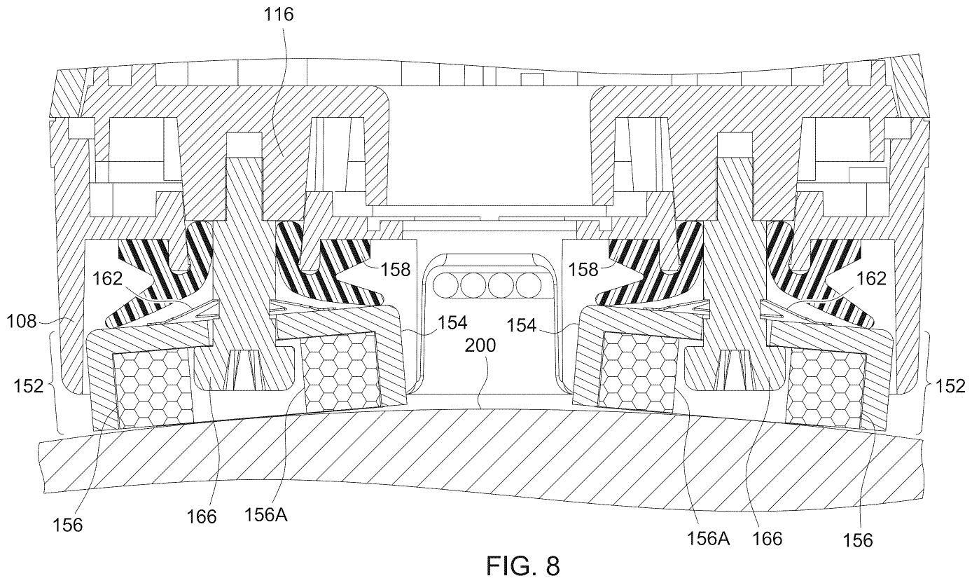

A cable channel 138 is present in the central portion of the base 108, recessed into the base (relative to the lower side 108A) to accommodate cables 132 extending from the antenna elements 124 and electronic components 120 located within the housing, through a central opening 136 formed in the lower side 108A, and to an external location. As shown, the cable channel 138 extends to opposing sides of the base 108 to provide an outlet for the cables 132 to either side of the base 108. The channel 138 provides a path for the cables 132, even when the lower side 108A of the base 108 is positioned on a mounting surface (such as mounting surface 200 shown in FIG. 8).

The arrangement of the magnetic mounting mechanisms 150, cable channel 138, and threaded fasteners 128 allows for a compact and efficient design. This configuration provides multiple points of magnetic attachment along the length and width of the antenna assembly 100 while also facilitating cable routing through the antenna assembly 100. The design enables secure mounting on various surfaces while maintaining the necessary connections for the operation of the antenna assembly 100.

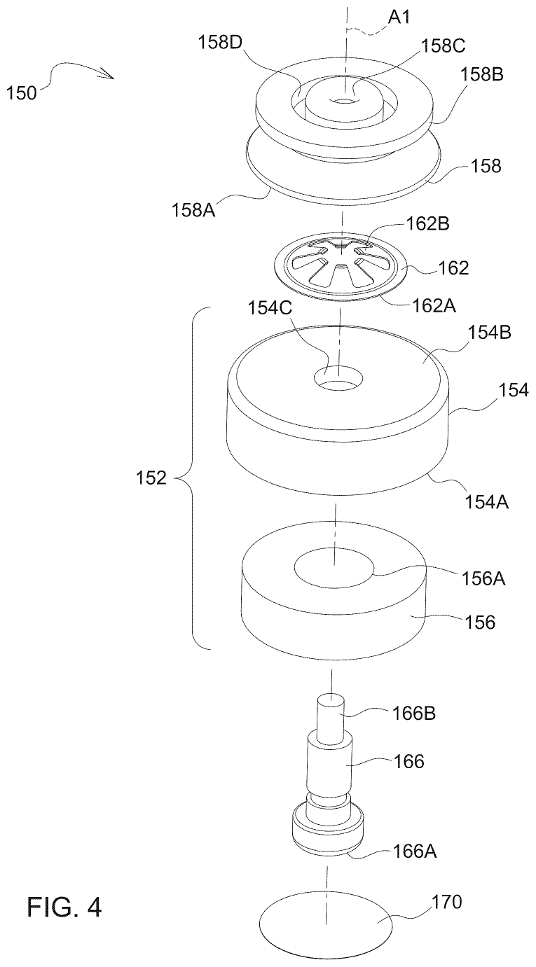

FIG. 4 illustrates an exploded view of the magnetic mounting mechanism 150. The magnetic mounting mechanism 150 includes several components arranged along a central axis A1. An articulator 158 is positioned at the top of the assembly. An upper side of the articulator 158 includes a chamber-engaging flange 158B and an upper recess 158D. A lower side of the articulator 158 includes a magnet-engaging flange 158A and a central opening 158C extends axially through the articulator 158.

A metal washer 162 is positioned beneath the articulator 158. The metal washer 162 includes an outer edge 162A and an inner edge 162B that defines a central opening. The metal washer 162 may feature a star-shaped pattern (e.g., an internal tooth washer) between the outer edge 162A and the inner edge 162B and may be non-planar between the outer and inner edges 162A, 162B (e.g., a crown washer), which enhances electrical contact.

Below the metal washer 162, a magnet 152 is formed of a magnet housing 154 and a magnetic element 156. The magnet housing 154 has an upper edge 154B, a lower edge 154A, and a central opening 154C. The magnetic element 156 is positioned within the magnet housing. The magnetic element 156 includes a central opening 156A. The magnetic element 156 is magnetic and is operable to engage a ferromagnetic surface (such as surface 200 in FIG. 8) to hold the antenna assembly 100 to the ferromagnetic surface.

A threaded fastener 166 extends through the center of the assembly. The threaded fastener 166 includes threads 166B and a head 166A. The threaded fastener 166 holds the magnet 152, washer 162, and articulator 158 together and secures them to the chassis 116. At the lower end of the assembly, a cover 170 may provide protection or a finished appearance to the underside of the magnetic mounting mechanism 150.

The arrangement of these components allows for rotational and translational movement of the magnet 152 relative to the base 108 and chassis 116. Translational movement includes movement of the magnet 152 along the axis A1 such that the magnet is movable relative to the chamber 140 to extend into or out of the chamber by different distances to accommodate mounting to different surfaces. Rotational movement includes both rotation of the magnet 152 about the axis A1 (e.g., a swiveling motion), and rotation of the magnet 152 relative to the fastener 166 to move out of plane with the lower side 108A of the base 108, as shown in FIG. 8. The articulator 158 facilitates and limits this movement while maintaining electrical grounding contact through the metal washer 162.

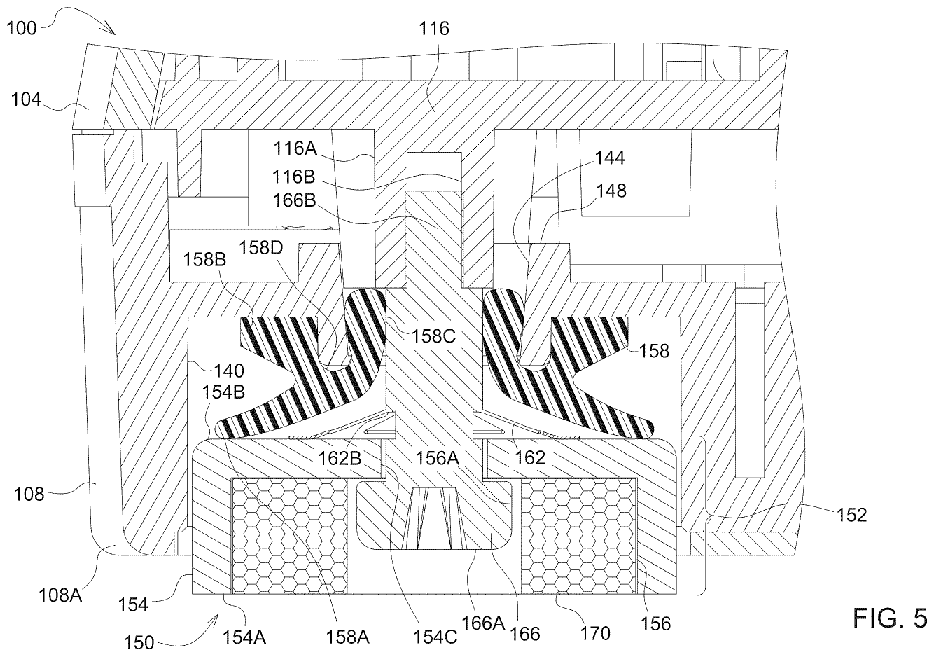

FIG. 5 illustrates a section view of the magnetic mounting mechanism 150 for the antenna assembly 100. While only a single magnetic mounting mechanism 150 is shown, the arrangement shown is similar for each mechanism 150. As described above with respect to FIGS. 1-4, the magnetic mounting mechanism 150 is located within a chamber 140 formed within the base 108 and open to a lower side 108A of the base 108. A chassis 116 positioned within the housing defined by the base 108 and cover 104 includes a boss 116A extending downward from the generally planar chassis, the boss 116A defining a threaded aperture 116B that receives the threaded end 166B of the fastener 166.

When mounted within the chamber 140, the magnet 152 of the magnetic mounting mechanism 150 extends into the chamber 140 and extends out of the chamber 140. In particular, when not compressed or rotated, the lower end of the magnet 152 (including the face of the magnetic element 156 that engages a ferromagnetic surface 200) is positioned below the lower side 108A of the base 108 and outside of the chamber 140. When compressed and/or rotated, additional portions (e.g., a portion of the lower edge, the entire lower edge) of the magnet 152 are moved into the chamber 140.

The fastener 166 couples the magnet 152 to the chassis 116. The fastener 166 is a threaded fastener 166 with a head 166A and threads 166B. The threaded fastener 166 extends through the magnet 152, articulator 158, and metal washer 162, as described above, and further extends through an aperture 144 formed within the chamber 140 of the base 108 that provides access for the fastener 166 to the chassis 116 positioned therein. The aperture 144 is formed within a boss 148 of the base 108 that extends upwards away from the chamber 140 and downwards into the chamber 140, such that the aperture 144 has a depth greater than the wall thickness of the base 108. The threads 166B of the fastener 166 are secured to the chassis 116 to secure the components of the magnetic mounting mechanism 150 to the chassis 116.

The articulator 158 is formed of an elastomeric material and is positioned within the chamber 140 between the chassis 116 and the magnet 152. The articulator 158 includes a magnet-engaging flange 158A that presses against an upper side of the magnet 152 (e.g., the magnet housing 154). The chamber-engaging flange 158B engages an upper side of the chamber 140 (within which the aperture 144 is formed), a surface of the base 108 that extends substantially parallel with the lower side 108A of the base 108. The chamber-engaging flange 158B also extends into the aperture 144 formed by the base 108 to seal against the fastener 166. The fastener 166 extends through and seals against the central opening 158C of the articulator 158. The upper recess 158D defined within the chamber-engaging flange extends around the boss 148 and permits the articulator 158 to surround the aperture 144 and provide a seal against moisture and debris. The articulator 158 simultaneously engages multiple surfaces including an interior wall of the aperture 144, the upper surface of the chamber 140, and the magnet 152. This multi-surface engagement provides stability and flexibility to the magnetic mounting mechanism 150 and rotational and translational movement of the magnet 152 relative to the base 108.

The articulator 158 may have a V-shaped cross-section in certain implementations. This V-shaped configuration may allow for greater flexibility and range of motion for the magnet 152. The V-shape compresses and expands as the magnet 152 moves, accommodating various surface contours while maintaining the position of other components within the magnetic mounting mechanism 150. The V-shaped cross-section of the articulator 158 may also contribute to the sealing function of the magnetic mounting mechanism 150 by engaging the magnet 152 at an angle nearer to parallel than perpendicular.

The articulator 158 may be made of silicone rubber. Silicone rubber may provide several advantageous properties that enable the articulator 158 to function effectively within the magnetic mounting mechanism 150. The elastomeric nature of silicone rubber allows the articulator 158 to deform and return to its original shape, facilitating the rotational and translational movement of the magnet 152 relative to the base 108. The silicone rubber material of the articulator 158 also exhibits high durability and resistance to environmental factors, contributing to the longevity of the magnetic mounting mechanism 150. The flexibility of the silicone rubber articulator 158 enables it to conform to different positions as the magnet 152 moves. This conformability may allow the articulator 158 to maintain its sealing function against the aperture 144 and the magnet 152, even as the magnetic mounting mechanism 150 adapts to curved or irregular surfaces.

The silicone rubber articulator 158 may be molded as a single piece. This unitary construction enhances the structural integrity of the articulator 158, simplifies the assembly process of the magnetic mounting mechanism 150, and aids in the watertightness. The molding process may allow for precise control over the dimensions and shape of the articulator 158, potentially optimizing its performance within the assembly. The silicone rubber material of the articulator 158 also provides vibration damping properties. This is beneficial in applications where the magnetic mounting mechanism 150 is subjected to vibrations, such as when mounted on vehicles. The vibration damping helps maintain the stability of the attachment and may protect sensitive components within the antenna assembly 100.

The articulator 158 seals the aperture 144. This sealing function is maintained irrespective of the rotational and translational movement of the magnet 152 relative to the base 108. The sealing capability of the articulator 158 helps protect the internal components of the magnetic mounting mechanism 150 from environmental factors such as moisture or dust. In some embodiments, the elastomeric articulator 158 directly seals against the threaded fastener 166 and directly seals against the aperture 144 to prevent water and dust intrusion. In some embodiments, the elastomeric articulator 158 directly seals against the magnet 152 to encapsulate the metal washer 162 between the elastomeric articulator 158 and the magnet 152.

The metal washer 162 is situated between the articulator 158 and the magnet housing 154. The outer edge 162A of the metal washer 162 engages the magnet 152 and the inner edge 162B of the metal washer 162 engages the fastener 166 regardless of motion (translation or rotation) of the magnet 152 relative to the fastener 166. The metal washer 162 therefore provides electrical grounding contact between the magnet 152 and the chassis 116 (indirectly via the fastener 166) irrespective of the rotational and translational movement of the magnet 152 relative to the base 108. In some embodiments, a recess is formed within the fastener 166 between the head 166A and the threads 166B that receives the inner edge 162B of the metal washer 162. When assembled, the washer 162 may be under compression between the magnet 152 and fastener 166. The metal washer 162 is encapsulated between the magnet 152 and the articulator 158. This encapsulation helps maintain the position of the metal washer 162 and prevents degradation of the metal washer 162, which may otherwise impact the capability of providing electrical grounding contact.

The configuration of the articulator 158, its engagement with multiple surfaces, and its sealing capabilities allow the magnetic mounting mechanism 150 to maintain its functionality and protection while adapting to various surface contours. The combination of the metal washer 162, the articulator 158, and the threaded fastener 166 work together to provide both flexibility in mounting and consistent electrical grounding. This arrangement allows the magnetic mounting mechanism 150 to adapt to various surface contours while maintaining essential electrical connections.

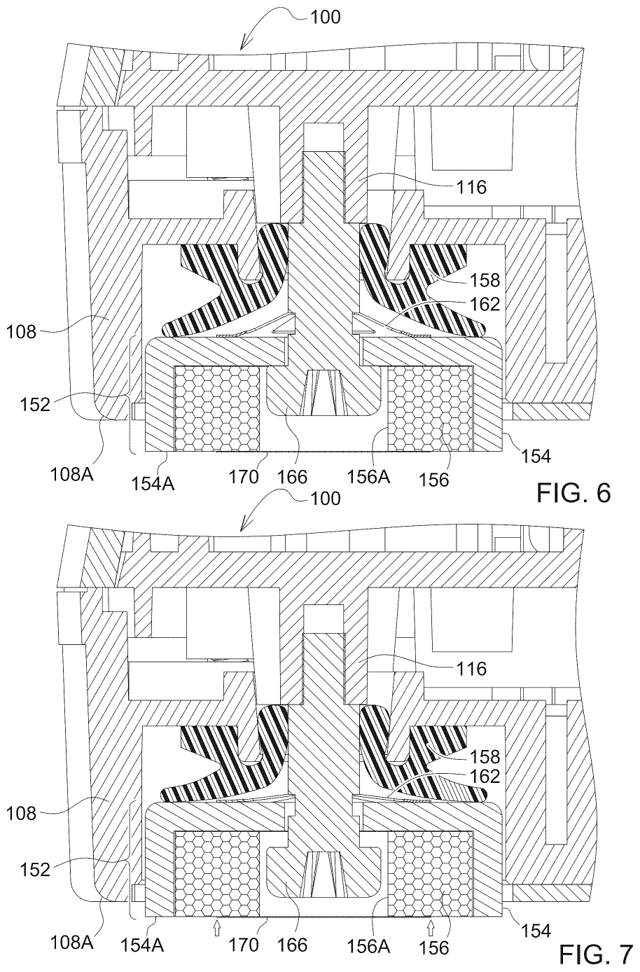

FIGS. 6 and 7 illustrate section views of the magnetic mounting mechanism 150 within the antenna assembly 100. In particular, FIG. 6 depicts the magnetic mounting mechanism 150 in a neutral position, and, in contrast, FIG. 7 shows the magnetic mounting mechanism 150 in a flexed position. When in the neutral position, the magnet 152 is pushed downward against the head 166A of the fastener 166 by the articulator 158 and the metal washer 162. When in a flexed position, for example, caused by engagement of one or more of the magnetic mechanisms 150 against a surface 200, the articulator 158 (e.g., the magnet-engaging flange 158A of the articulator 158) is compressed, the metal washer 162 is axially compressed, and the magnet 152 moves axially away from the head 166A of the fastener 166.

The independent movement capabilities of the magnetic mounting mechanisms 150 allow first and second magnets 152 of two mechanisms 150 to simultaneously conform to a curved surface. This adaptability enables the antenna assembly 100 to maintain secure attachment on various non-planar surfaces while preserving the functionality of the antenna.

FIG. 8 illustrates a section view of two magnetic mounting mechanisms 150 of the antenna assembly 100 adapted to a curved surface 200. Each of the two magnetic mounting mechanisms 150 is substantially similar, though are spaced apart from one another within separate chambers 140 formed in the lower side 108A of the base 108.

The separate articulators 158 of the two mechanisms 150 permit each of the two magnets 152 to move independently of one another to engage the ferromagnetic surface 200 located directly adjacent (i.e., below) the respective magnet 152. As such, while central axes of the two magnetic assemblies are parallel to one another in their neutral positions, they are transverse to one another, as shown, when mounted to a curved surface, as the lower surface of each of the magnetic elements 154 is rotated and translated to an orientation that is substantially parallel with the surface 200 at the point of engagement with the magnet 152.

The independent movement and grounding capabilities of the first and second magnets 152 enable the magnetic mounting mechanism to adapt to a wider range of surface contours while maintaining electrical integrity. For example, the first magnet 152 and the second magnet 152 are configured to simultaneously conform to a curved surface, with each magnet 152 potentially moving in a different direction or to a different degree while maintaining its respective ground contact through its associated metal washer 162.

The configuration of multiple chambers 140, magnets 152, articulators 158, and metal washers 162 provide enhanced adaptability and reliability for the magnetic mounting mechanism. This arrangement allows for secure attachment to a variety of surface shapes while maintaining consistent electrical grounding for each magnet 152, improving the overall performance and versatility of the antenna assembly 100.

While described in FIG. 8 with respect to two or more magnetic mounting mechanisms 150, the advantages of incorporating a magnetic mounting mechanism 150 movable relative to the base 108 is also applicable with only a single magnetic mounting mechanism 150, especially in implementations where the base 108 is large relative to the mounting surface 200 or use with a significantly non-linear surface. In such scenarios, the base 108 may engage the surface 200 in a way that separates the magnetic mounting mechanism 150 from the surface 200. A non-movable magnetic mounting mechanism 150 may be incapable of reaching and securely engaging the surface 200 or may otherwise position the base 108 at a non-desirable angle relative to the surface 200. By utilizing a movable magnetic mounting mechanism 150, strong engagement with the surface 200 is more easily accomplished.

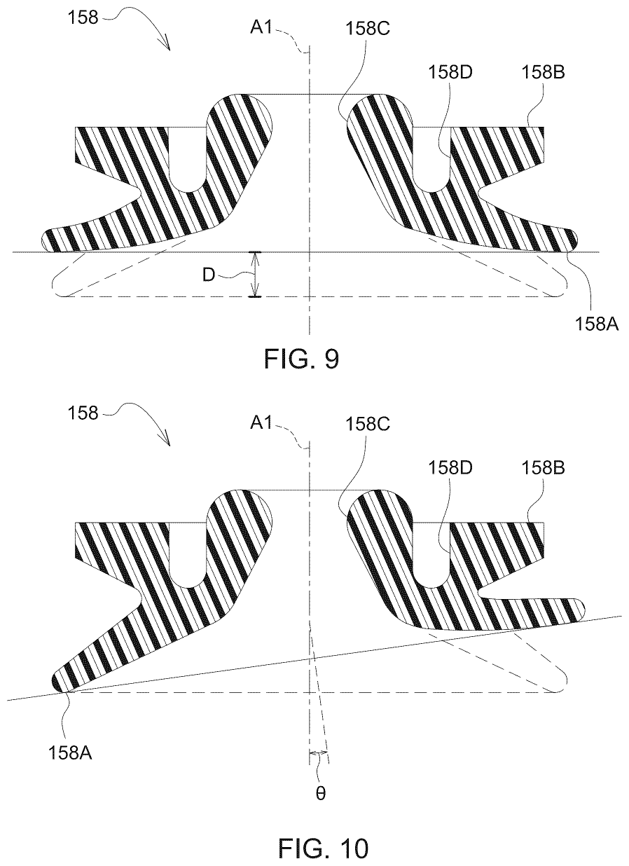

FIGS. 9 and 10 illustrate section views of a flexible articulator 158 for the magnetic mounting mechanism 150. The flexible articulator 158 is made of an elastic material, allowing it to deform and return to its original shape. This design enables the articulator 158 to provide rotational and translational movement, which can be useful in the magnetic mounting mechanism 150 for adapting to curved surfaces or allowing adjustable positioning.

FIG. 9 shows the flexible articulator 158 in an axially compressed position (shown in solid lines) relative to a neutral position (shown in dashed lines). The distance D illustrates the axial deformation from the neutral position to a maximum axial deflection. At the maximum axial deflection, the material properties of the articulator 158 may prevent further movement without significantly increased force and/or tearing. Alternatively, the magnet engaging flange 158A or magnet 152 may contact a surface (e.g., the interior of the chamber 140), thereby preventing further axial movement.

FIG. 10 depicts the flexible articulator 158 in a flexed position, where the magnet 152 presses against the magnet-engaging flange 158A to rotate relative to the base at an angle θ. The angle θ indicates the degree of flexion of the magnet-engaging flange 158A from the neutral position. Similar to the axial displacement, the rotational displacement may be limited by the material properties of the articulator 158 and/or interferences between the articulator or magnet 152 within the chamber 140. The magnet assembly is capable of significant angular adjustment. For example, the articulator 158 allow the magnet 152 to tilt up to 23 degrees (e.g., at least 20 degrees, at least 15 degrees, at least 10 degrees) from its neutral position. This range of motion enables the magnetic mounting mechanism to conform to highly curved or irregular surfaces while maintaining a secure attachment.

While FIGS. 9 and 10 separately illustrate translation and rotation of the articulator 158, the configuration of the flexible articulator 158 allows for simultaneous translation and rotation. The arrangement allows for a range of motion in multiple directions. For example, the angled magnet-engaging flange 158A shown in FIG. 10 represents a tilting motion of the magnet relative to the base or chassis. Simultaneously, the compression and expansion of the central opening 158C allows for vertical translation of the magnet.

The ability of the flexible articulator 158 to deform while maintaining its overall structural integrity allows for consistent performance of the magnetic mounting mechanism across various surface contours. The flexibility enables the mechanism to adapt to curved or irregular surfaces while maintaining a secure magnetic attachment and preserving electrical connections.

In some aspects, the magnetic mounting mechanism may provide IP67 rated environmental protection. This rating may indicate that the mechanism is dust-tight and can withstand water immersion up to 1 meter depth for 30 minutes. The sealing capabilities of the articulator 158 and the enclosed design of the chamber 140 may contribute to this level of protection.

The magnetic mounting mechanism is versatile and suitable for mounting various devices beyond antenna assemblies. In some cases, the mechanism may be used for attaching surveillance cameras, modems, radio modules, satellite plates, or speakers to ferromagnetic surfaces. This adaptability allows for flexible deployment of different equipment in various environments.

A number of implementations have been described. Nevertheless, it will be understood that various modifications may be made without departing from the spirit and scope of the disclosure. Accordingly, other implementations are within the scope of the following claims.

What is claimed is:

1. A magnetic mounting mechanism comprising:
a base including a chamber formed therein;
a chassis positioned adjacent the base;
a magnet extending into the chamber; and
an articulator formed of an elastomeric material and positioned within the chamber between the chassis and the magnet, wherein the articulator provides rotational and translational movement of the magnet relative to the base.

2. The magnetic mounting mechanism of claim 1, further comprising a fastener coupling the magnet to the chassis.

3. The magnetic mounting mechanism of claim 2, wherein the fastener is a threaded fastener threaded into engagement with the chassis.

4. The magnetic mounting mechanism of claim 1, wherein the base is a base of a housing having a cover coupled to the base, and wherein the chassis is separable and removable from the housing.

5. The magnetic mounting mechanism of claim 1, wherein the chamber is a first chamber, the magnet is a first magnet, and the articulator is a first articulator, the magnetic mounting mechanism further comprising:
a second chamber formed within the base and spaced apart from the first chamber;
a second magnet positioned at least partially within the second chamber; and
a second articulator formed of an elastomeric material and positioned within the second chamber between the chassis and the magnet,
wherein the second articulator provides rotational and translational movement of the second magnet relative to the base independent of rotational and translational movement of the first magnet such that the first magnet and the second magnet are configured to simultaneously conform to a curved surface.

6. The magnetic mounting mechanism of claim 1, further comprising a metal washer configured to provide electrical grounding contact between the magnet and the chassis irrespective of the rotational and translational movement of the magnet relative to the base.

7. The magnetic mounting mechanism of claim 6, wherein the metal washer is encapsulated between the magnet and the articulator and indirectly provides electrical grounding contact between the magnet and the chassis via a threaded fastener.

8. The magnetic mounting mechanism of claim 1, wherein the chamber includes an open end through which the magnet is positioned within the chamber, and an upper surface opposite the open end, wherein the upper surface includes an aperture extending from the chamber to the chassis, and wherein the articulator simultaneously engages an interior wall of the aperture, the upper surface of the chamber, and the magnet.

9. The magnetic mounting mechanism of claim 8, wherein the articulator seals the aperture irrespective of the rotational and translational movement of the magnet relative to the base.

10. A magnetic mounting mechanism comprising:
a base including a chamber formed therein;
a chassis positioned adjacent the base;
a magnet extending into the chamber;
an articulator positioned within the chamber between the chassis and the magnet, wherein the articulator provides rotational and translational movement of the magnet relative to the base; and
a metal washer configured to provide electrical grounding contact between the magnet and the chassis irrespective of the rotational and translational movement of the magnet relative to the base.

11. The magnetic mounting mechanism of claim 10, further comprising a threaded fastener threaded into engagement with the chassis and coupling the magnet to the chassis.

12. The magnetic mounting mechanism of claim 11, wherein the metal washer is encapsulated between the magnet and the articulator.

13. The magnetic mounting mechanism of claim 11, wherein the threaded fastener extends through an aperture of the base between the chassis and the magnet, and wherein the articulator seals the aperture irrespective of the rotational and translational movement of the magnet relative to the base.

14. The magnetic mounting mechanism of claim 10, wherein the chamber is a first chamber, the magnet is a first magnet, and the metal washer is a first metal washer, the magnetic mounting mechanism further comprising:
a second chamber formed within the base and spaced apart from the first chamber;
a second magnet positioned at least partially within the second chamber; and
a second metal washer configured to provide electrical ground contact between the second magnet and the chassis irrespective of the rotational and translational movement of the second magnet relative to the base.

15. A magnetic mounting mechanism for an antenna assembly, the magnetic mounting mechanism comprising:
a chassis configured to support said antenna assembly; and
a threaded fastener coupled to the chassis, the threaded fastener extending through, in order: a magnet, a metal washer, an elastomeric articulator, and the chassis,
wherein the elastomeric articulator provides rotational and translational movement of the magnet relative to the chassis.

16. The magnetic mounting mechanism of claim 15, wherein the chassis is coupled to a base of a housing, and wherein the threaded fastener extends through an aperture of the base.

17. The magnetic mounting mechanism of claim 16, wherein the base defines a chamber, and wherein at least a portion of the magnet, the metal washer, and the elastomeric articulator are positioned within the chamber.

18. The magnetic mounting mechanism of claim 16, wherein the elastomeric articulator directly seals against the threaded fastener and directly seals against the aperture to prevent water and dust intrusion.

19. The magnetic mounting mechanism of claim 18, wherein the elastomeric articulator directly seals against the magnet to encapsulate the metal washer between the elastomeric articulator and the magnet.

20. The magnetic mounting mechanism of claim 15, wherein ground contact between the chassis and the magnet is maintained via the metal washer and the threaded fastener irrespective of rotational and translational movement of the magnet relative to the chassis.
